(19) United States
(12) Patent Application Publication
(10) Pub. No.: US 2004/0117293 A1
(43) Pub. Date: Jun. 17, 2004

(54) Automated auction sales management tool

(76) Inventors: Randall Warren Lammle, Plymouth, MN (US); Michael Gerard Schrenk, Richfield, MN (US); Mark D. Saliterman, Bloomington, MN (US)

Correspondence Address: Beck & Tysver, P.L.L.C., Suite 100, 2900 Thomas Avenue S., Minneapolis, MN, 55416, US

(21) Appl. No.: 10/404,410

(22) Filed: Apr. 1, 2003

Related U.S. Application Data
(60) Provisional application No. 60/433,444, filed on Dec. 13, 2002.
(60) Provisional application No. 60/442,296, filed on Jan. 23, 2003.
(60) Provisional application No. 60/446,471, filed on Feb. 11, 2003.

(51) Int. Cl. G06F 17/60

(52) U.S. Cl. 705/37

(57) ABSTRACT

An automated tool for submitting items to an auction site is presented that allows multiple users to share a single seller identity. The present invention maintains confidentiality from sales person to sales person, and allows a sales manager to input details about an auction that are hidden from the sales persons. Managers assign items to sales people, who are then responsible for completing the auction posting. Communications from bidders are automatically routed to the assigned sales person. The sales manager monitors all details relating to the auctions and the performance of the individual sales agents. A management system can implement business rules that enforce certain behaviors on the sales people. A verification system is also presented for verifying the ownership of automobiles submitted to an auction site for sale.

### CLAIM OF PRIORITY

This application claims priority to the following three provisional patent applications: U.S. Ser. No. 60/433,444 filed Dec. 13, 2002; U.S. Ser. No. 60/442.296 filed Jan. 23, 2003; and U.S. Ser. No. 60/446,471 filed Feb. 11, 2003.

### FIELD OF THE INVENTION

This invention relates to the field of automated auction management tools. More particularly, the present invention relates to an auction management tool that allows the assignment of inventory items to particular sales people, and further allows managers to monitor and restrict the activities of their sales force.

### BACKGROUND OF THE INVENTION

Online auction sites such as eBay (eBay Inc., San Jose, Calif.), Yahoo!, (Sunnyvale, Calif.) and uBid (Chicago, Ill.) generally require that sellers register with the site before they can offer any items through the site. The auction site stores information about the seller in a database, such as name, phone number, and e-mail address, and then assigns the seller a unique identity or alias. The seller can then access the site using that identity and a secret password, and then submit items for sale on the auction site. Similarly, purchasers that want to make bids on items sold on the auction site must also register and obtain a unique identity with the auction site.

When an item is put up for auction, the auction site associates that item with the identity of the seller. If a bidder has a question for the seller, the bidder submits the question to the auction site, and this question is automatically forwarded to the e-mail address of the seller that is stored in the auction site database. When a bid is made, the auction site records the bid, and notes the bid and the bidder's alias on the page describing the item for sale.

One problem with this system is that the auction site database generally allows each seller to be associated with only a single e-mail address. The limitation of a single e-mail address per seller works well for individual sellers and small businesses that employ only a few people. But the existing system poses problems for institutional sellers and larger retailers who employ multiple salespeople to sell items in online auctions, mainly because all the sales people are forced to share the single e-mail address associated with the identity of the retailer.

A single auto retailer, for example, may have thirty cars involved in online auctions, with the responsibility for handling and selling these cars being assigned to multiple sales people. With only a single address being associated with a seller identity, all inquiries generating by these auctions will be sent to the same e-mail address, forcing the sales people to manually separate and identify which e-mails are intended for which sales person.

One solution to this problem is to create a separate online auction identity for each salesperson. Unfortunately, the use of multiple identities creates branding issues for companies that want to promote a single brand. This is especially true where the auction site allows potential buyers to see a seller's rating or feedback from prior buyers. No retailer wants the valuable ratings and feedback of happy customers to be diluted over multiple selling identities.

In addition to branding problems, the use of multiple seller aliases also complicates billing and shipping issues for a large retailer. With multiple identities, individuals who are responsible for collecting payment and arranging delivery of sold items are forced to monitor the e-mail received for each identity used to sell the product. Multiple identities also create problems in that the retailer must track and maintain the confidentiality of multiple passwords.

Auction management facilities such as CarAd.com, Mr. Lister, Turbo Lister, and ManageAuctions.com have done little to improve the situation for a retailer with multiple salespeople. In the CarAd.com solution, all items sold through an auction site are sold under a single identity. CarAd.com does assist with inventory management and auction submission. In addition, CarAd.com also automates some aspects of communicating with bidders during and after an auction, such as by allowing the retailer to respond to inquiries using preset paragraphs via an integrated e-mail system, and by always placing a link to a particular auction on the same page that the retailer uses to review the inquiry. However, in systems such as this, all messages generated by a retailer's online auctions are grouped together, reflecting the fact that all items are submitted to the auction site using a single identity. The grouping of all communications together requires that a retailer either provide all sales people with access to the entire list of received e-mails, or that a sales manager manually review and forward the messages to the appropriate sales people.

In addition, these prior art systems do not provide the ability to link an item in inventory with a particular salesperson responsible for selling that item. This means that there is no ability to monitor and control the activities of individual sales people in connection with the auctioning of items.

### SUMMARY OF THE INVENTION

The present invention overcomes the problems in the prior art by creating a multi-user auction submission system. With the present invention, a retailer is able to use a single seller identity while having multiple sales people be responsible for their own auctions. The present invention maintains confidentiality from sales person to sales person, and is able to automatically handle message delivery to the appropriate salesperson assigned to an item. This occurs even though all items are submitted to the auction site using a single identity.

The present invention uses a database that maintains an inventory of items and allows a sales manager to assign items to individual salespeople for an auction. The database presents screens that provide information about the items to sales managers, and allows the manager to select manager level options for each auction. The sales person assigned to an item then inputs or verifies additional details for the auction, and submits the auction to the automated auction site. The present invention insures that the sales manager is able to monitor and evaluate all details relating to the auctions, while providing only a limited subset of that information to the sales agents. A management system can implement business rules that enforce certain behaviors on the sales people, such as requiring a response to outstanding e-mails before posting additional items for bid, or requiring that items be posted in the order in which they were assigned to the sales person.

Bidders on the auctions see only a single entity as the seller, and address all communications to the entity as a whole. A communications router in the present invention examines all communications from bidders for an item number, auction number, or similar identifying information, and then routes the communication to the sales person handling that auction.

### BRIEF DESCRIPTION OF THE DRAWINGS

FIG. 1 is a schematic drawing showing the grouping of items in an inventory database, including the assignment of groups to separate sales people and the posting of items to automated auction sites.

FIG. 2 is a flow chart of the overall method used in the present invention.

FIG. 3 is a schematic drawing showing the possible paths of data acquisition for the inventory database used in the present invention.

FIG. 4 is an example user interface screen showing inventory to a sales manager.

FIG. 5 is an example user interface screen showing summary data concerning an inventory item in worksheet form.

FIG. 6 is an example user interface screen allowing a sales manager to assign an inventory item to a sales person.

FIG. 7 is an example user interface screen showing a sales person their assigned inventory, new e-mail, and schedule events.

FIG. 8 is an example user interface screen allowing a sales person to review and revise item details before submitting the item to the auction site.

FIG. 9 is a schematic diagram showing the four components used by the present invention to automatically submit items to an auction site.

FIG. 10 is a schematic diagram showing the communication routing between multiple bidders using multiple auction sites and multiple salespeople using the communications router of the present invention.

FIG. 11 is an example user interface screen showing an inquiry e-mail to a sales person and allowing for a response.

FIG. 12 is a flow chart showing the process of obtaining bidder contact information from an auction site.

FIG. 13 is an example user interface screen showing the scheduling of a follow up event with a bidder.

FIG. 14 is a flow chart showing a preferred embodiment of business rules that can be utilized to control sales personnel behavior with the present invention.

FIG. 15 is a schematic diagram showing the use of a scheduler to monitor events and automatically perform certain activities.

FIG. 16 is a data model chart of a preferred data model for the present invention.

### DETAILED DESCRIPTION OF THE INVENTION

Overview of System

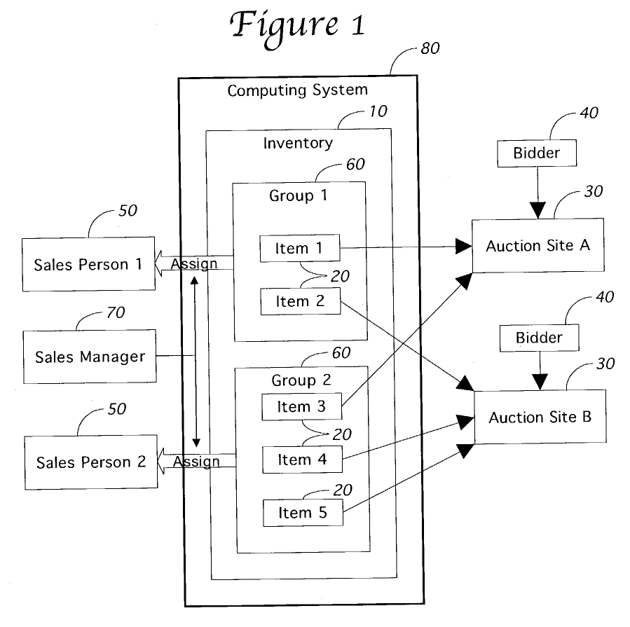

FIG. 1 shows the environment in which the present invention is used. An electronic inventory 10 is maintained of multiple items 20, such as by using a database. This database 10 maintains information about the items 20, and can contain additional information relating to the present invention. The items 20 can be any product or service that can be auctioned over an automated auction site 30, such as consumer goods, wholesale industrial products, personal and professional services, and collectables. For purposes of explaining the present invention, the current description will assume the items 20 comprise new and used automobiles. This assumption is merely for convenience, and is not intended to limit the scope of the present invention.

The items 20 can be submitted to one or more auction sites 30 to allow users or bidders 40 of those sites 30 to bid on the items 20. In the preferred embodiment, the present invention is able to work seamlessly with a variety of different auction sites 30. This allows the items 20 to be strategically posted to the auction site or sites 30 that gives the retailer the greatest likelihood of a successful auction at a reasonable cost. The performance of each site 30 can be analyzed empirically, with the results used to aid in future posting decisions.

In the present invention, the items 20 are assigned to a sales person or agent 50, who is responsible for communicating with bidders 40, and, if the auction does not successfully sell the item 20, for following up with bidders 40 in an attempt to sell the item 20. The items 20 that are assigned to a single sales person 50 can be collectively referred to as the group 60 of items 20 assigned to that sales person 50. In the present invention, communications concerning the items 20 in a sales person's group 60 are automatically routed to the appropriate sales person 50. A sales person 50 does not have access to communications concerning items 20 not found in their group 60, which maintains confidentiality between sales persons 50 and prevents one sales person 50 from selling an item 20 that was assigned to a different sales person 50. This is especially useful when the items 20 being sold are automobiles or the like, where sales persons 50 are compensated primarily on the commissions made on relatively few sales.

It should be clear that where FIG. 1 shows items 20 and groups 60 being assigned to a sales person 50, it would be well within the scope of the present invention for the items 20 and groups 60 to be assigned to a sales team comprising more than one person. The present description uses the singular term sales person 50 to aid in understanding the invention. However, this use should not be understood to limit the scope of the invention.

In the preferred embodiment of the present invention, a sales manager 70 assigns the items 20 to the sales person 50. Ideally, sales manager 70 assigns the item 20 before the item 20 has been posted to the is auction site 30. This allows the sales manager 70 to set some of the values associated with the posting of the item 20 to the site 30, while requiring that the sales persons 50 verify and input any remaining data. For example, the sales manager 70 will usually desire to set the reserve price for the auction. The reserve price determines the minimum price for which the item 20 will be sold in the auction. In the context of automobiles and similar products, it is often undesirable to let the sales persons 50 know the reserve price. Thus, the preferred embodiment allows sales manager 70 to set the reserve price for an item 20 when the item 20 is assigned, and then prevents the assigned sales person 50 from seeing this price.

Ideally, the present invention is implemented within the context of a computing system 80 comprising one or more computers. The computing system 80 has access to the auction sites 30 through one or more computing networks, such as the Internet. In addition, the computing system 80 has user interfaces to allow the sales people 50 and one or more sales managers 70 to interact with the system 80. In the preferred embodiment, these interfaces are browser interfaces using known communication and programming techniques, including the use of HTML, Java Script, Java, and XML.

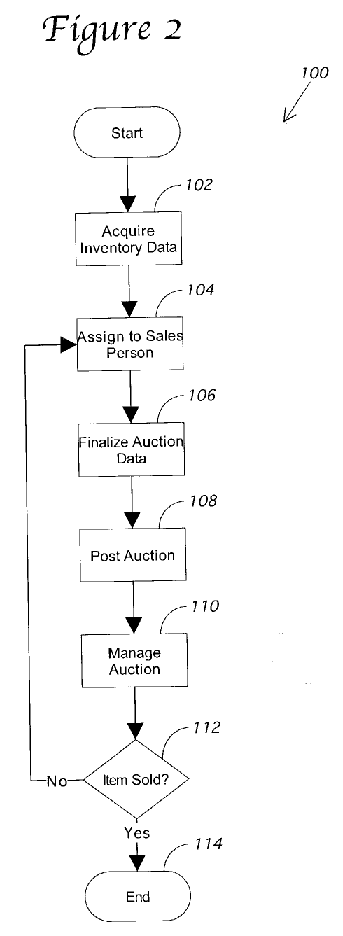

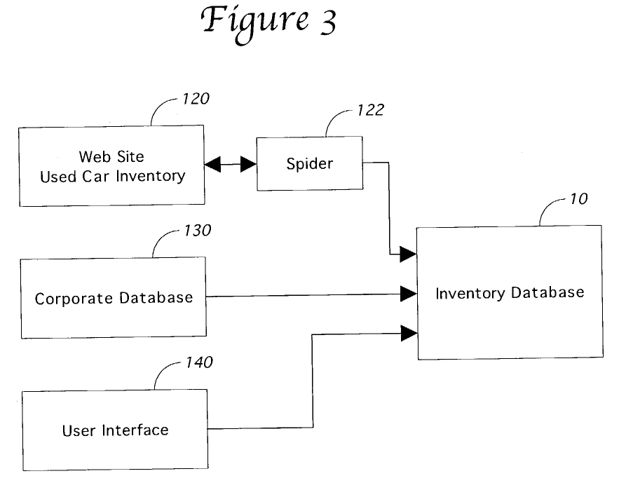

FIG. 2 shows the general method 100 utilized by the present invention, the details of which are discussed below in connection with FIGS. 3-15. The first step 102 of this method is to acquire the data necessary to create an inventory 10 of the items 20 that will be submitted to the auction sites 30. This inventory 10 preferably takes the form of a database having sufficient information on each item 20 so as to identify the item and its worth to the sales people 50 and sales manager 70. In addition, the database 10 ideally has sufficient information about the items 20 so that the submission to the auction site 30 can be made primarily or exclusively by using data from the inventory database 10.

The next step 104 is for the sales manager 70 to assign an item 20 in the inventory database 10 to a sales person 50. This step 104 can be accomplished by assigning items 20 one-by-one to the sales person 50, as makes sense in automobile retailing, or by assigning an entire class of items 20 as a group 60. If the items 20 are assigned as a group 60 according to a class or characteristic of the items 20, the method 100 can assign all items 20 having that class or characteristic to the designated sales person 50 without intervention of the sales manager 70 on an item-by-item basis.

After the item 20 is assigned, the sales person 50 in the preferred embodiment reviews and supplements the data in the database 100 for submission to the auction site 30 in step 106. This step will likely include reviewing the look and format of the auction data and ensuring that all data about the item 20 is accurate. In step 108, the item is posted to the auction site 30, allowing bidders 40 to review and bid on the item 20. The posting step is preferably automated, with the computing system 80 of the present invention interfacing directly with the auction sites 30 to submit the item 20 for auction. To the extent the auction site provides an automated interface (an API) for submitting data to the site, the computing system 80 will use that interface. If no such interface is available, the computing system 80 will interact with the auction site 30 like any user manually posting an item for auction, except without direct interaction from any human user.

In step 110, the assigned sales person 50 and the sales manager 70 can manage the auction. This step includes such activities as tracking the bids and the bidders on the item, communicating with the bidders, and lowering the reserve price for the auction. When the auction as completed, step 112 determines whether the item 20 has been sold. If so, payment is collected and the product is delivered as part of ending step 114. If the item 20 has not been sold, it can be reassigned in step 104 and reposted as a new auction. One benefit of the present invention is that all information about an auction is stored to aid sales managers 70 in determining how to post an item 20 to a subsequent auction. Some auction sites 30 give refunds for reposting an item 20 to a subsequent auction, but they require that the reserve price be lowered in order to obtain this refund. The present invention allows the sales manager 70 the option of “reposting” the item 20 in a way to obtain this refund, or, alternatively, posting the item 20 afresh without having to abide by the rules of the auction site 30 for reposting.

Acquiring Data

FIG. 3 shows schematically a few of the various ways in which step 102 of acquiring data for the inventory database 10 can be performed. A first way to do this is to obtain the data from a web site 120 that already contains the data. One example of this would be an automobile dealership that has already contracted with a vendor to maintain an automated inventory of their automobiles on a web site available to the public. One advantage of obtaining the data from such a source is that the vendor typically has arranged to obtain photographs of the dealer's cars for the web site. The data is extracted from the web site 120 by a spider 122 that crawls through all the pages of the site and extracts all of the data and photographs relating to the items 20 that are found on the site 120.

Another method is to obtain the information directly from a preexisting corporate database 130. Generally, data in one database can be obtained by another through an automated query, report generation, or through an exportation of data. Whether the information for the inventory database 10 is obtained from a web site 120 or a corporate database 130, it is highly preferred that this data extraction be completely automated and preformed on a regular basis in order to keep the inventory database 10 as current as possible.

A third method of entering data into the inventory database 10 is manual entry through a user interface 140. This method is obviously not preferred, but would allow the database 10 to be created and maintained even when there is no ability to automatically generate and update the data.

Of course, none of these methods would be necessary if all of the data for inventory 10 already exists in a database that can simply be used for the purposes of inventory 10 in the present invention.

Assigning Items

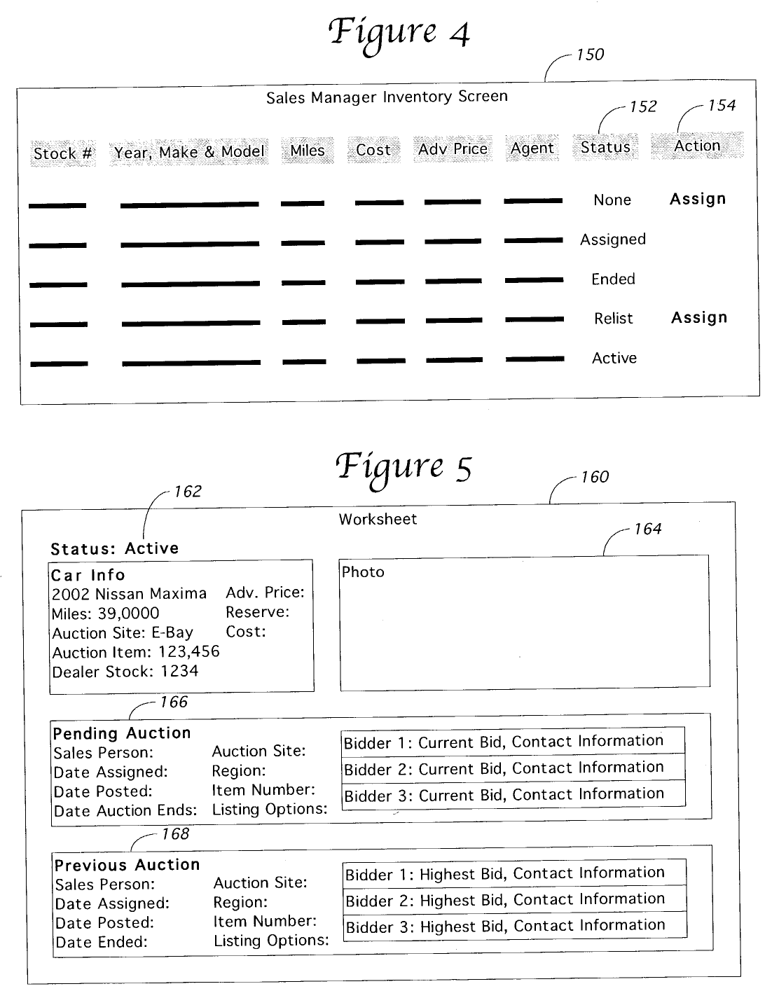

In the preferred embodiment, the sales manager 70 is able to view the contents of the inventory 10 through an inventory screen 150, such as that shown in FIG. 4. This screen 150 allows the sales manager 70 to view the entire inventory 10 of items 20, as well as key information about the items 20. Specifically, on screen 150 each item 20 is listed with identifying information (such as stock number, year, make, model, and mileage of a car), cost to the retailer, publicly advertised price (such as the “Internet Price”), as well as the assigned sales person 50 (if any) and the current status 152 of the item 20 in the computing system 80. In the preferred embodiment, the possible status 152 values for an item 20 are shown in the following table:

| STATUS | DESCRIPTION |
|---|---|
| None | The item has no connection with any auction. |
| Assigned | The item has been assigned to a sales agent, but the agent |
| | has not begun posting the item. |
| Pending | The sales agent has started posting the item, but has not |
| | completed the posting process. |
| Active | The auction and bidding have started for the item. |
| Ending | The auction is about to end, and the pre-close period has |
| | started. The “pre-close” period is a preset amount of time |
| | before the end of the auction. |
| Ended | The auction has ended without a winning bid, but is still in the |
| | closing period. The “closing period” is a preset period of time |
| | that a sales agent has to sell a car after an auction has ended |
| | and the reserve price was not met. |
| Sold | The car has been sold. A car can be sold by the placing of a |
| | winning bid, or a negotiation with a bidder during the closing |
| | period. |
| Relist | The auction has ended, and the closing period is over. A |
| | “relist” status indicates that the car can be reassigned to a |
| | sales agent for another auction. |

In the preferred embodiment, it is possible to zoom into a screen containing more detailed information about an item, such as the item worksheet screen 160 shown in FIG. 5. In this example worksheet screen 160, the current status 162 of the item 20 is shown first, followed by detailed information about the item including a photograph 164. The screen 160 then shows information about each time the item 20 has been posted to auction. The pending auction is listed first at 166, including information about the agent 50 to whom the item 20 was assigned, when the item 20 was assigned and posted, and when the auction ends.

The worksheet screen 160 includes additional information about the pending auction, including the auction site used, and the region selected. Auction sites such as eBay associate some of their items into particular regions, such as metropolitan areas and states. Some sellers, such as automobile sellers, find it useful to list their items for sale in a particular region, even if the seller and the item being sold are not located in that region. Thus it is useful for the worksheet to present the region in which the item 20 was posted on the auction site 30. The worksheet 160 also lists the item number used by the auction site 30 to identify the item 20, which generally is presented as a hypertext link to the auction page on the auction site 30. Furthermore, the worksheet 160 preferably includes the listing options used when posting the item 20. Listing options are generally added cost items that the auction site 30 allows a poster to select to highlight their item 20, such as bold type, special logo, etc. Finally, the worksheet 160 shows a list of bidders, including the bidders name, current bid, and contact information.

Worksheet screen 160 actually shows this information for two separate auctions, the pending auction at 166 and a previous auction at 168. This allows a sales manager 70 to quickly analyze the results of earlier auctions for this item 20. If there were more than one previous auction 168 for this item 20, all such auctions 168 would be listed.

Returning to the inventory screen of 150, it is obvious that it might be useful for a sales manager 70 to view a subset of the items 20 in inventory 10 as opposed to the entire inventory 10. Search facilities and commonly desired lists could be presented to the manager 70 so that only certain items 20 are listed, such as items 20 currently up for auction, items assigned to a particular sales agent 50 or items 20 currently available for assignment. In addition, it might be useful to include some of the information shown on the worksheet screen 160 within the list of items 20 shown on the inventory screen 150, such as the current high bid and bidder 40 for active status items 20. While this is not shown explicitly on screen 150, it would be within the scope of the present invention to alter this screen in these or other manners.

In the preferred embodiment, once an item 20 has been assigned, it cannot generally be reassigned to another sales agent 50 until after the auction for the item 20 has been completed and the sales agent 50 has had the opportunity to close a sale. To make this clear to the sales manager 70, the sales manager inventory screen 150 includes an action coluim 154 indicating which items 20 can be assigned. If the item 20 has never been assigned, it has a status of none and can be assigned at any time. Alternatively, if the status is “relist,” the auction and closing period have ended, and the item 20 can be reassigned to a new sales agent 50.

In one embodiment of the present invention, a sales manager can revoke an item from a sales person 50 at any time. In this embodiment, every item shown in FIG. 4 that does not have an “Assign” action 154 would have a “Revoke” action 154. However, this ability is generally not preferred since it can cause confusion concerning item 20 assignments among the sales agents 50.

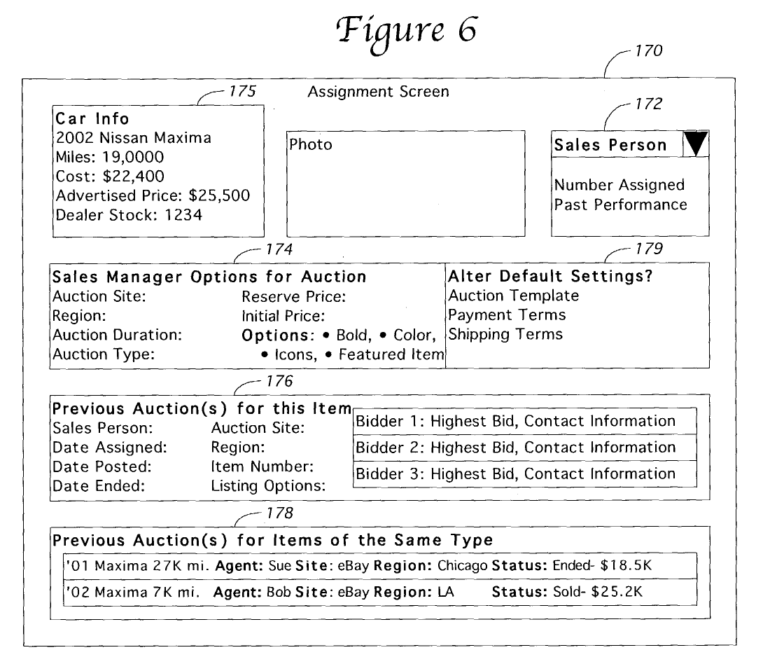

Ideally, the sales manager 70 uses an assignment screen 170 such as shown in FIG. 6 to make the assignment of an item 20. Ideally, the manager 70 makes this selection by choosing from a list of sales agents 50 known to the computing system 80 of the present invention, such as via a pull-down selector 172. This screen 170 also allows the sales manager 70 to assign certain values 174 to the item 20 for the auction, including the reserve price for the item 20. The sales manager can set this price according to their professional judgment and the cost information for that item 20 that is stored in the database and presented to the manager in area 175. The cost and reserve price can be kept secret from the assigned sales person 50 in order to prevent the sales person from revealing the reserve price to a potential buyer and thereby short circuiting the advantages of a hidden reserve price. In the preferred embodiment, the sales manager is also presented with past auction history for this item 176 and the past history for similar items 178.

The sales manager 70 can set a variety of values 174 for an auction, including the auction site 30 to be used, as well as the auction region, duration, and type of auction as may be allowed by the auction site 30. The sales manager 70 is also asked to select the added price options that the auction site 30 provides for an auction, such as bold face type, special icons, and making the item 20 a featured item on the site 30. By letting the sales manager 70 make the determination on these options, the present invention prevents the sales people 50 from adding extra cost options to their auctions that the manager 70 does not think are cost effective. Finally, the assignment screen 170 also allows the sales manager 70 to override certain default values at area 179, such as the template to be used for the auction and the acceptable payment and shipping terms.

Posting Items

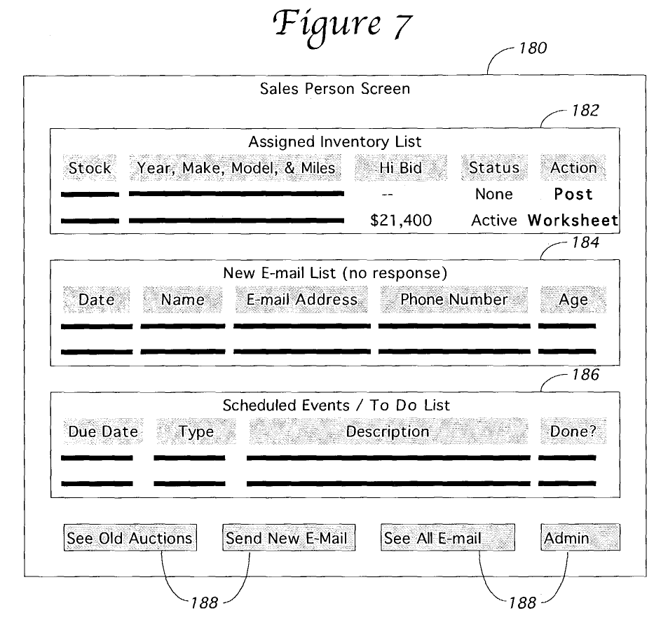

When a sales person or agent 50 logs into computing system 80, they are presented with a sales person information screen 180, such as shown in FIG. 7. In the preferred embodiment, this screen 180 is designed to present the sales person 50 with three types of information: assigned inventory 182, correspondence 184 that needs to be reviewed and responded to, and events or to do items 186. One of the primary advantages of the present invention is that this screen shows only information relevant to the actual sales person 50. Only the items 20 assigned to the sales person 50 are shown in inventory list 182, only e-mails relating to those items 20 appear on list 184, and only to do items relevant to the sales person 50 are shown at 186. From this screen, the Agent 50 can zoom in for more information about the listed items 20, correspondence, or to do items. Information about the items 20 will be shown in a worksheet 160 such as that shown in FIG. 5. The worksheet 160 shown to Agents 50 would not disclose confidential information sown to Managers 70, such as the reserve price or the cost of the item 20.

The sales person screen 180 also includes option buttons 188 to allow the agent 50 to perform additional actions. These additional actions include seeing old auctions (items that were sold or otherwise past the closing period), sending new e-mails not in response to an incoming e-mail or to do item, see all e-mail instead of just new e-mail needing responses, or performing administrative functions such as changing contact information or passwords. Alternatively, old auctions and e-mail could simply be included in the inventory list 182 and e-mail list 184, respectively.

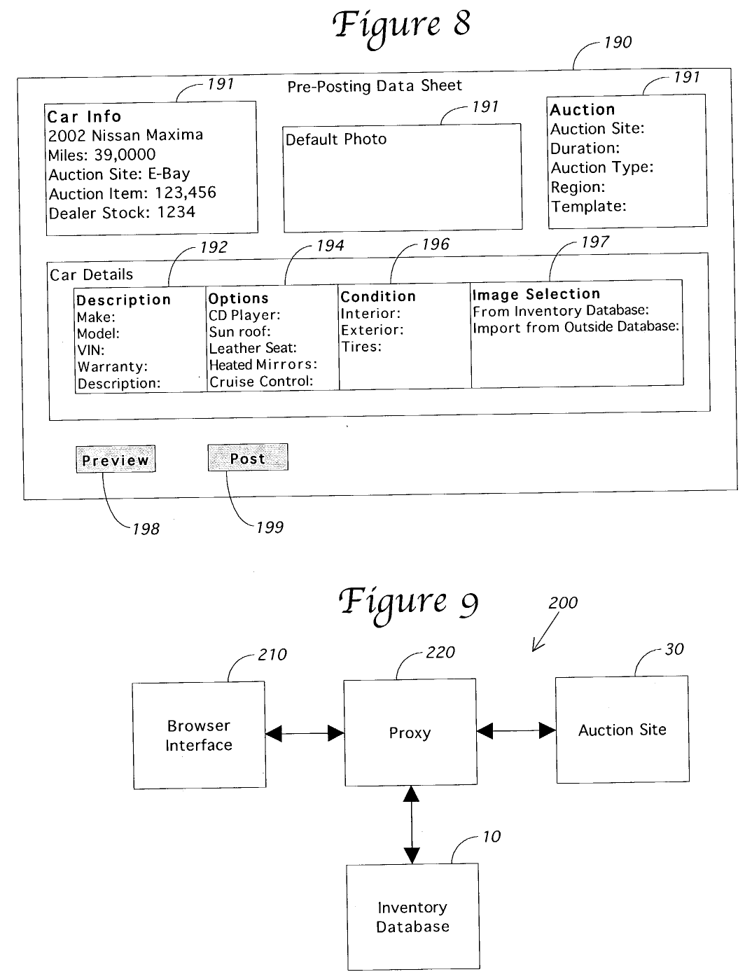

When the sales person 50 is ready to post an item 20, she selects the post action for that item 20 from the assigned inventory list 182. Most of the information necessary to post an auction for that item 20 is already found in the inventory database 10, from either the data collection techniques shown in FIG. 3 or from the information provided by the sales manager 70 when the item 20 was assigned. Nonetheless, it is important for the sales person 50 to verify this information and be given the opportunity to update and correct the information. This is accomplished through one or more pre-posting data screens 190 shown on FIG. 8. Information about the item 20 and the sales manager selected options are shown in areas 191. Screen 190 is designed to allow the sales person 50 to verify and supplement information about the item 20. For example, where the item 20 is a used vehicle, the sales person reviews and updates information on the vehicle's description 192, options 194, and condition 196. The screen 190 will encourage the sales person 50 to write a written description for the vehicle, although a standard description can be automatically generated by the computing system 80. Screen 190 also allows the sales person 50 to select the images to be used in the auction in area 197, based upon images already in the inventory database 10 or by importing the images from elsewhere. Changes and additions to this information are then stored in inventory database 10. When the sales person 50 is finished, she can either preview the auction as it will look on the auction site 30 by hitting button 198, or can immediately post the item 20 to the auction site 30 by hitting post button 199. Templates are then used to create the auction page from the information stored in inventory database 10 as updated through screen 190. The template is generally selected by default for all auctions, but can be changed by the sales manager on the item assignment screen 170.

The computing system 80 is designed to automate all aspects of submitting an item 20 to an auction site 30 once the sales person 50 requests the posting. If the auction site 30 provides a programming interface for the posting of items 20 for auction, then the computing system 80 will use that interface. Such interactions are well understood by those of ordinary skill.

Very often, however, the auction site 30 does not provide such an interface, and instead allows items 20 to be posted only through a multiple-step, manual process using forms presented to a user through a browser interface. To avoid having the sales person 50 fill out and submit multiple forms for the auction site, the computing system 80 uses the components shown in system 200 of FIG. 9 to post the item 20. The system 80 uses its own browser interface 210 to present the previously described screens 150, 160, 170, 180, and 190 to the sales manager 70 and sales person 50. The information received through the browser interface 210 is then merged with the data existing in the inventory database 10 through a proxy system 220 that interacts with the selected auction site 30. The proxy system 220 begins by logging into the auction site 30 under the single identity associated with the user of the present invention. The proxy system 220 then interacts with the auction site 30 as if it were a user submitting an item to the site 30 through the multi-step forms provided by the site 30. The general technique for automatically filling out forms presented by a web site in this manner is well known in the prior art. In one embodiment, the sales person 50 is informed of the progress made by the proxy system 220 as it interacts with the auction site 30, such as by showing the sales person 50 one or more of the screens filled out by the proxy system 220 for submission to the site 30. If the sales person 50 is allowed to interact with and change the screens, it is necessary for the proxy system 220 to make various alterations to the screen before it is presented to the user, such as populating the form fields, changing navigation and other actions to force navigation to travel through the proxy system 220, and adding or removing web elements as needed. Alternatively, the proxy system 220 works completely in the background, and merely informs the sales person 50 when the submission to the auction site 30 is complete.

Communications With Bidders

One major benefit of the present invention is that it provides unique auction management facilitates for both the sales person 50 and the sales manager 70. For instance, the presence of the proxy system 220 allows the computing system 80 to periodically query the auction site 30 to determine the current status of an auction, including the current high bid and bidder. This information is used to update the status information for the items 20 in the inventory database 10, which is then shared through a user interface such as screens 150 through 190.

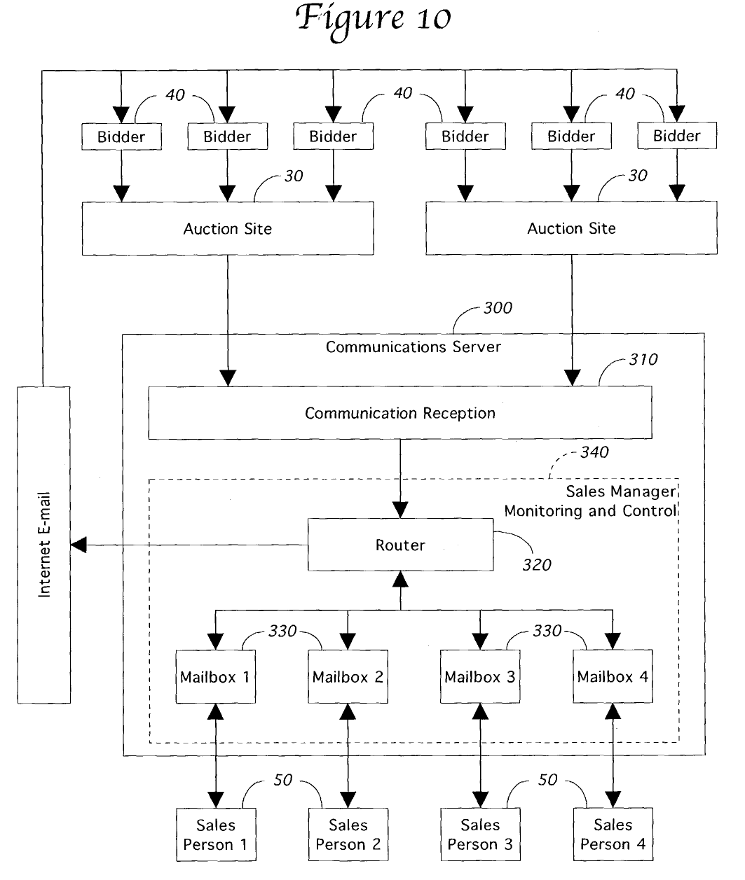

The present invention also receives all correspondence from bidders 40 about the items 20 put up for auction on the auction sites 30. In the preferred embodiment, this is accomplished using a communications server 300 as shown in FIG. 10. As seen in this figure, multiple bidders 40 are able to interact with one or more auction sites 30 on which the items 20 are being auctioned. When the bidder 40 wishes to send a message to the seller, most auction sites 30 require that the communication occur through the site 30 itself. This helps the site 30 monitor the communication for compliance with its policy of discouraging side deals that prevent the site 30 from collecting a commission on the sale. This process also allows the site 30 to include a message along with the communication from the bidder 40, such as a request not to enter into side deals. Generally, the message is then forwarded to the single communication address recorded in the database of the auction site 30 for the seller, such as an e-mail address. If the message is sent as an Internet e-mail, the communication server receives the message by a communication reception device 310 in the form of a standard POP or IMAP mailbox maintained by a mail server. Alternatively, the messages could be presented to the communication reception device 310 in a format other than e-mail, such as storing or submitting the messages to a communications database that is accessible by the communications reception device 310. Either way, the communication reception device is responsible for receiving the messages from the bidders 40 via the single communication address associated with the seller in the database of the auction site 30.

These messages are then analyzed by a router 320 that is capable of routing messages to the responsible sales people 50 based on the content of the subject line or message body. This is accomplished by comparing identifying information in the message header, such as in the subject line, or in the message body with data found in the inventory database. For example, at the time of this application, the eBay auction site 30 includes an item number in the subject heading of all e-mails sent to a sender about an auction. The router 320 analyzes the incoming e-mails received at device 310 for this item number, finds the corresponding entry for the item 20 in the inventory database 10, and determines the sales person 50 assigned to this item 20.

Once the sales person 50 is determined, the communications server 300 places the message in the mail box 330 accessible by that sales person 50. These mailboxes could consist of standard POP or IMAP mailboxes. It would also be possible to automatically forward messages to individual e-mail accounts, pagers, PDAs, wireless devices, or other communication systems outside the control of communications server 300. However, the preferred embodiment maintains greater control over the messages by storing the messages in a database and providing agents 50 with browser access to the mail boxes 330.

When a sale person 50 responds to a message, the reply is also stored in the database, and then sent back to the appropriate bidder by the router 320 through standard Internet e-mail techniques. This is possible since the message sent on by the auction site 100 includes the bidder's e-mail address. In addition, since replies to bidder messages are sent directly back through this system 300, the system 300 can hide the bidder's actual e-mail address from the sales person 50 if such secrecy is needed to keep all messages flowing through the system 300.

The primary benefit of using the communications server 300 is that all messages regarding the online auctions flows through the server 300, which allows the server 300 to log and store all messages in a database. This allows a sales manager 70 to track various performance criteria about the auctions and the manage the performance of the sales people 50, which is shown conceptually in FIG. 10 as dashed box 340. Specifically, the preferred embodiment tracks when e-mails are answered by a sales person 50, the originating e-mail address of all messages, the number of leads generated by each posted item 20, as well as the total number of inquiries that a sales person 50 handles.

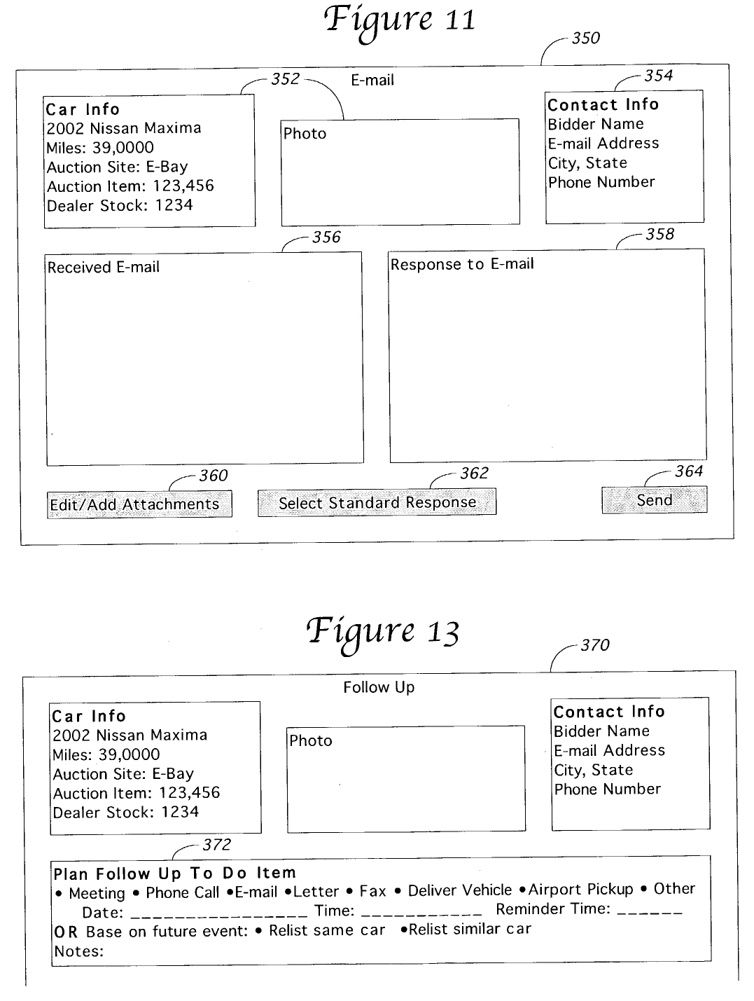

When a sales person 50 receives an e-mail in their mailbox 330, it will appear in area 184 of screen 180, thereby informing the agent 50 that a message has been received that needs their attention. In the preferred embodiment, the agent 50 merely clicks on the e-mail listed in area 184 to see e-mail screen 350, as shown in FIG. 11. This screen 150 identifies the item 20 through text and a photograph in areas 352, and also identifies the bidder who sent the e-mail in area 354. The bidder's information in area 354 includes the bidder's name, address, phone number, and e-mail address.

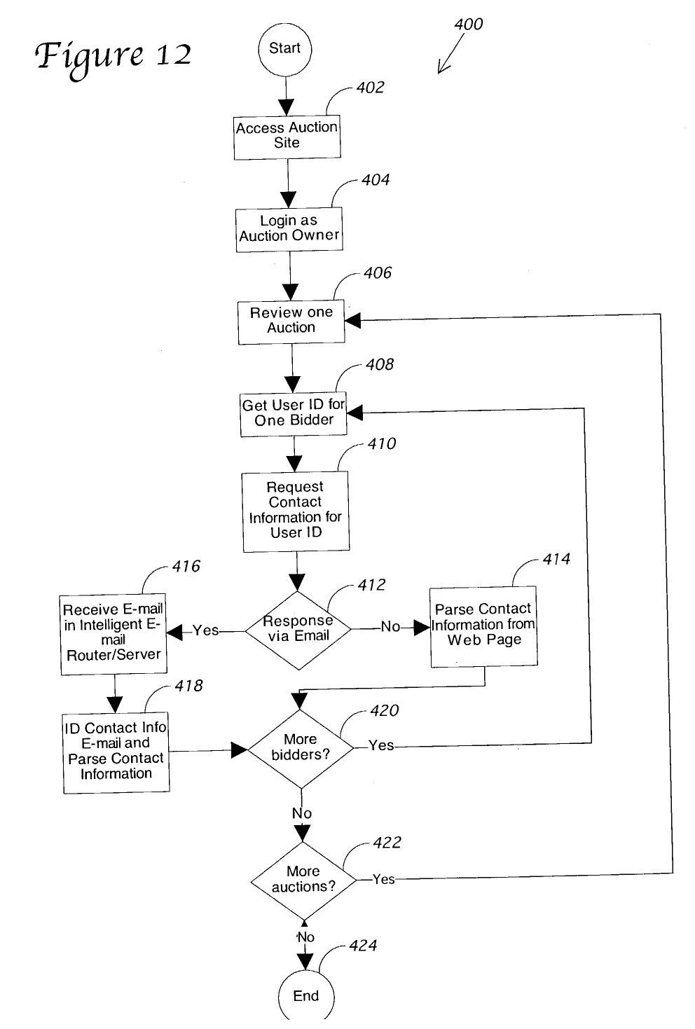

Some of the bidder's information is found within the message or e-mail sent by the auction site 30, but other contact information about the bidder 40 must be obtained by directly communicating with the auction site 30. The present invention accomplishes this task using a bidder contact information gathering process 400 shown in FIG. 12. This process 400 allows the present invention to gather contact information on many or all of the bidders 40 who bid on the items 20, regardless of whether they have the winning bid or whether they initiate contact with the seller. The present invention can then share this information with the sales manager 70 or the assigned agent 50, without revealing the information to agents 50 who are not assigned to the relevant auction.

This process 400 begins with the computing system 80 used by the present invention accessing the auction site 30 at step 402 and logging into the site 30 at step 404. The computing system 80 then navigates through the site 30 to obtain information on a particular auction at step 406. This page will generally contain the identity of at least one bidder 40 for this auction. This identity is selected in step 408. The computer system 80 then requests contact information about that bidder 40 directly from the auction site 30 at step 410. The process used by the auction site 30 may differ depending upon the site 30. If step 412 determines that the information is returned by the auction site 30 via a web page, step 414 examines that web page and parses the contact information for the bidder 40 out of that page. If the information is returned by e-mail to the seller's identity, the computer system 80 will wait until the communications server 300 receives the e-mail. When it is received at step 416, it is then parsed for the contact information at step 418. Step 420 determines if any other bidders are listed on the auction page such as on auction sites 30 that list all bidders 40 on an item 20. If so, the next bidder identity is selected at step 408. If there are no more bidders 40 associated with this auction, the computer system 80 determines at step 422 if any more auctions are pending for items 20 in inventory 10 at this auction site 30. If so, the next auction is selected at step 406. If not, the process ends at step 424. Some web sites will list only the current highest bidder 40 at a given time for an auction. In these environments, it is useful to repeat process 400 many times during a day so as to collect the bidder contact information for as many bidders 40 as possible for each auction running on an auction site 30. In addition, it would not be necessary to have the process 400 wait at step 416 to return an e-mail from the auction site 30 before requesting information on additional bidders 40 auctions at steps 420 and 422. Instead, the method 400 could request contact information for all available bidders 40 before parsing the e-mails in step 418.

Returning now to e-mail screen 350, the contact information collected through process 400 is shown to the sales person 50 in area 354. Area 356 is where the received e-mail is displayed. The sales agent 50 then writes a response to the e-mail in area 358. Button 360 can be used to add or otherwise change any attachments that are to be sent with this e-mail. Button 362 allows the sales agent 50 to select standard text to be used in the e-mail response. A sales manager 70 can pre-define numerous standard responses that can be used by the sales agents 50. Alternatively, the sales agent 50 can define their own standard responses that are available through button 362. Finally, button 364 is selected to send the e-mail response back to the bidder 40. The e-mails sent by the computer system 80 to bidders 40 will contain both an identifying number and a plain English description of the item 20, which is derived from correlating the item number and information in the database 10. All e-mails will also automatically contain contact information for the sales agent 50 who is assigned to selling the item 20.

In the preferred embodiment, every time a sales agent 50 sends an e-mail to a bidder 40, the computing system 80 presents a follow up screen 370 to the sales agent 50. This screen repeats the item identifying information and contact information found on the e-mail screen 350 at areas 352 and 354. In addition, this screen 370 allows the agent to set a follow up “to do” item at area 372. The follow up item can be set to a particular date and time, or can be set according to future activity in the system (such as re-listing the same car, or listing a similar car). The possible types of follow up items include a meeting, a phone call, an e-mail, a letter, a fax, a vehicle delivery, and an airport pick up. The follow up item created by this screen 370 will appear on the agent's sales person screen 180 in area 186. Although it is not described in more detailed, the preferred embodiment would assist the sales agent 50 in completing this follow up item, such as by automatically entering the e-mail screen 350 when the sales agent 50 selects an e-mail to do item from area 186, or by automatically generating a follow up letter or fax for that type of to do item.

In one embodiment of the present invention, the computing system 80 requires that a follow up event be set for every e-mail sent by an agent 50. Alternatively, the computing system 80 determines if a follow up item already exists for this bidder 40 in connection with this item 20. If not, then a new follow up item must be created after the e-mail is sent. If the agent 50 chooses not to create such a follow up item, the agent 50 is requested to enter a brief explanation and the sales manager 70 is so informed.

Management Of Sales Persons 50

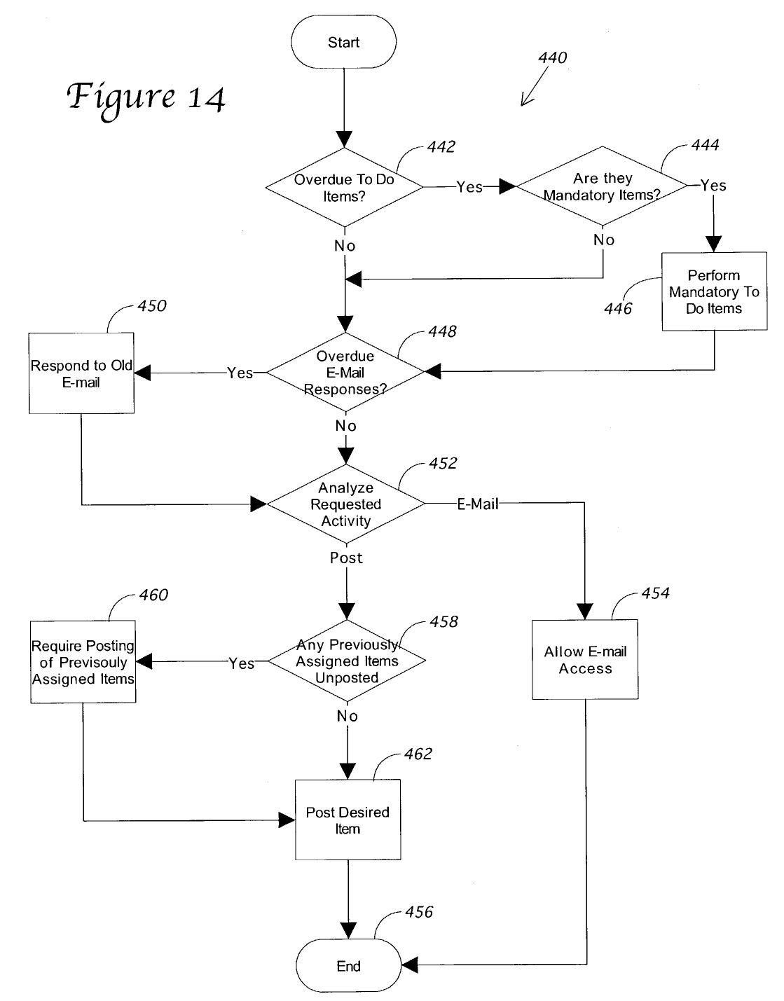

By automating the assignment of items 20, the posting of items 20 to the auction sites 30, and the handling of bidder communications, the present invention gives sales managers 70 the ability to both monitor sales people 50 and control their actions. In other words, the computing system 80 of the present invention allows the manager 70 to impose certain business rules on the actions of the sales agents 50 regarding the posting of items 20 to auction sites. One example set of business rules is set forth in the flow chart of management control 440 shown in FIG. 14. Under these business rules, an agent 50 is not allowed to submit e-mails or post items 20 to auction sites until the computing system 80 has analyzed the agent's past activity. More specifically, the process 440 first checks at step 442 whether there are any to do items for the sales person 50 that are overdue. In the preferred embodiment, to do items can be labeled as mandatory if they are not to be skipped. Thus, if the agent 50 does have overdue to do items, step 444 determines if they are mandatory or not. If they are mandatory, step 446 requires that the agent 50 perform the to do item before continuing. If they are not mandatory, the agent 50 need not perform the action. Of course, it would be a simple matter to implement process 440 without step 444, meaning that all overdue to do items are mandatory and must be performed at step 446.

Once overdue to do items are check, step 448 determines whether the agent 50 has any overdue e-mails requiring a response. In one embodiment, all e-mails deserve a response before the agent 50 can take any other action. In other embodiments, e-mails need only be responded to within a preset time period. In still further embodiments, e-mails can be prioritized, such as by placing a higher priority on e-mails relating to auctions that are about to close. Other ways of prioritizing e-mails might focus on initial customer inquiries, repeat inquiries from same customer, communications from winning bidders after an auction has closed, or responses from customers who responded to “reserve not met” or “auction nearly over” automatic e-mails (described in more detail below). These priorities can be used to determine which e-mails require responses at step 448, and can also be used to alter the display and order of e-mails in area 184 of screen 180 (FIG. 7). Regardless of how step 448 determines whether e-mails are pending that need a response, step 450 will require this response if step 448 so determines.

Next, step 452 checks to see what activity is desired by the agent 50—sending an e-mail message or posting an item 20. Of course, other activities could be monitored by method 440 other than e-mails and posting, but these two activities are presented for purposes of illustration. If the agent 50 desires only to send an e-mail message, this is allowed in step 454 and the process ends at step 456.

If the agent 50 desires to post an item 20, step 458 determines whether the item 20 they wish to post is the oldest un-posted item 20 currently assigned to the agent 50. If not, the process 440 requires that the oldest assigned un-posted item is posted first. In this way, the computing system 80 requires the posting of items 20 in the order in which they are assigned to the sales person 50 at step 460. Once the older un-posted items 20 have been posted (if any), the computing system 80 allows the agent 50 to post the desired item at step 462, and the process ends at step 456.

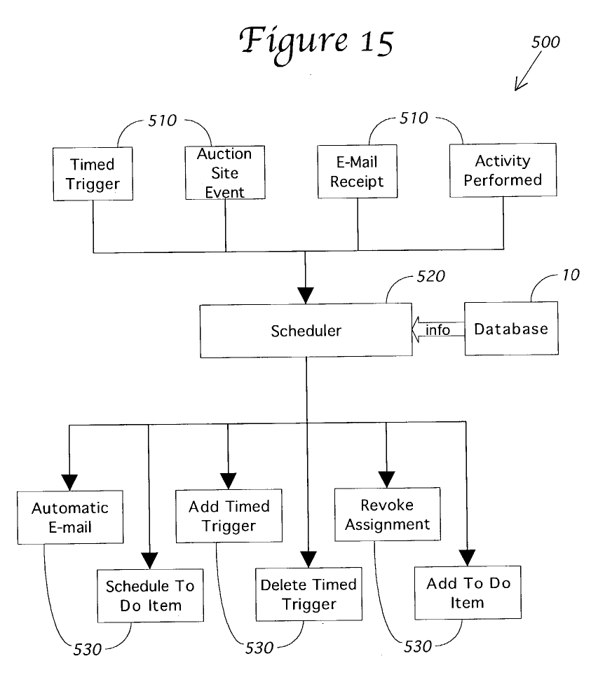

In addition to controlling the actions of individual sales persons 50 using the computing system 80, the present invention allows the computing system 80 to perform certain events automatically. This is accomplished using a system 500 such as that shown in FIG. 15. This system 500 responds to certain triggering events 510. One type of trigger 510 is a timed event, which triggers an event at a certain time (such as six days after an item 20 is posted to a site 30). Events at the auction site 30 such as a new high bid can also serve as triggers 510. These events can be discovered through the monitoring methods described above to monitor status changes or new auction bidders. The receipt of an e-mail or the performance of an activity by a user of the computing system 80 (such as sending an e-mail, assigning an item 20 to an agent 50, or posting an item 20 to an auction site 30) can also serve as a triggering event.

When a triggering event occurs, it is noticed by a scheduler component 520. This component 520 has access to the database 10 maintained by the system, and can therefore access information about items 20, auctions, bidders 40, sales people 50, and sales managers 70. With this information, the scheduler is able to perform certain activities 530. FIG. 15 shows five different types of activities 530: sending an automatic e-mail, scheduling a to do item, deleting a to do item, adding a timed trigger, deleting a timed trigger, and revoking an assignment. One skilled in the art would recognize that the triggers 510 that trigger the scheduler 520 and the events 530 that can be performed by the scheduler are infinite in variety, and that the particular triggers 510 and events 530 shown in FIG. 15 are merely examples showing the possibilities.

The system 500 is capable of performing a great deal of business management for the computing system 80. In the preferred embodiment, for instance, automated e-mails are sent to bidders on the occurrence of particular triggers 510. These automated e-mails are described in the following chart:

| Trigger | Automated E-mail |
|---|---|
| New | This e-mail thanks a new bidder and explains who to contact |
| Bidder | for more information (the assigned agent 50). This e-mail may |
| | or may not be sent depending on the results of a comparison |
| | between the bid price and the reserve price |
| Pre-Close | Sent during the “pre-close” period, this e-mail might be sent |
| Period | to the top three bidders reminding them the auction will soon |
| | close. |
| Auction | Some period after the auction ends, an e-mail message will |
| Closed- | be sent to the top bidders on the item 20 concerning the |
| No Sale | possibility of purchasing the item by negotiating with the |
| | sales person 50. |
| Car Sold | Some period after the auction ends, an e-mail message will |
| | be sent to the winning bidder 40 confirming that they won, |
| | payment instructions and step-by-step instructions for what |
| | to do next. |
| No | If no response is heard form a winning bidder 40, an e-mail |
| Response | will be sent to the winning bidder again confirming that they |
| after Sale | won the auction and instructions similar to the “Car Sold” |
| | e-mail, but with added consequences for not fulfilling |
| | their part of the sale agreement. |

The “New Bidder Trigger” is a simple auction site event trigger 510 that can be detected using the process shown in FIG. 12. The “Pre-Close Period” is a timed trigger 510, which was set by the scheduler 520 at the time the auction was posted. The “Auction Closed-No Sale” and the “Car Sold” triggers are both auction site event trigger 510 that can be monitored by the computing system 80. The “No Response after Sale” event is a timed trigger 510 set at the same time the car sold automatic e-mail is sent. Note that when an e-mail is received from the winning bidder, this e-mail will serve as its own trigger 510 causing the “No Response after Sale” timed trigger to be deleted. Ideally, the triggering events 510 and the contents of these automated e-mails will be settable by the sales manager 70.

The system 500 can also be used to automatically revoke an assignment if the assigned agent 50 does not post the item 20 within three days of the assignment. This can be accomplished by having a timed trigger set whenever an assignment of an item 20 is made. This timed trigger states that in three days, the assignment will be revoked. Whenever an item 20 is posted, that activity acts as a trigger 510 to delete the timed trigger 510 set to revoke the assignment. Thus, unless the posting occurs within the three-day period and causes the timed trigger 510 to be deleted, the timed trigger 510 will automatically revoke the assignment.

Obviously, by maintaining a database of items 20, assignments to sales agents 50, auctions, and auction results, a great deal of information is stored in the computing system 80 relating to the performance of the sales agents 50. This information is available to sales managers 80 interested in evaluating the performance of the agents 50. One way of measuring performance is lead follow-up, which is the period of time between when an e-mailed inquiry regarding a sale item is made, and when the sales agent responds to the inquiry. In the preferred embodiment, a sales manager 70 can also create a report card for their agents 50 showing: i) number of cars posted, ii) number of cars sold (including make and model), iii) number of leads they followed-up on, iv) number of pending messages they need to send out, v) number of pending auctions they need to post, and vi) number of cars actively running in auctions, and vii) percentage of cars assigned that were sold by the agent 50. Sales managers may also monitor the messages sent to and from the sales persons 50 and verify that all inquiries are properly answered. Finally, the preferred embodiment also allows the sales manager 70 to determine the cost effectiveness of various auction strategies, such as using certain auction sites 30, regions, options, etc. by comparing the cost and results of various combinations.

Database

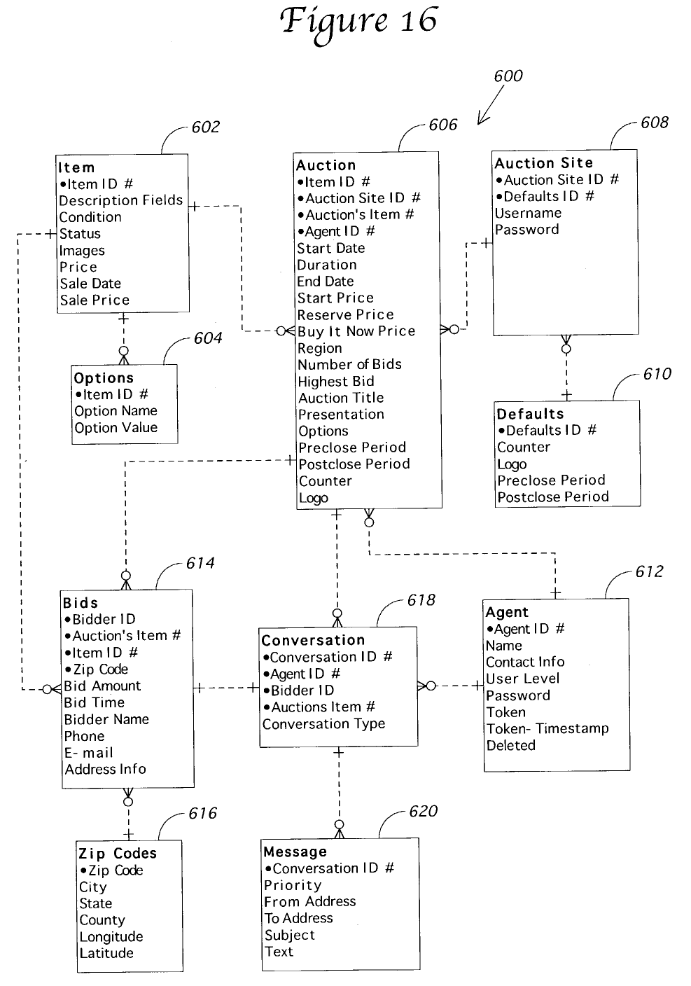

FIG. 16 shows a simple version of the data model 600 used to implement the present invention. Items 20 are stored in an item table 602 that is uniquely identified by an item ID number and contains addition fields that describe the item and its current condition. The item table 602 also contains fields for the current status of the item, links to images associated with the item, the price or cost of the item, the sale date of the item, and the sale price. In one possible environment, the items 20 are used and new automobiles. In this environment, it is useful to create an options table 604 that contains one or more options for each item 20. The connector on FIG. 16 between the options table 604 and the items table 602 indicates that these two tables are linked in a many-to-one relationship, with each item in table 602 having zero, one, or many related options in table 604.

When an item 20 is assigned to a sales person 50, a record in the auction table 606 is created. Since a single item 20 can be involved in many auctions, the auction table 606 is linked to the item table 602 by a many-to-one relationship via the Item ID number. The auction table 606 also has an auction site ID # that links each auction 606 with an auction site in the auction site table 608. The auction site table 608 contains one entry for each auction site 30. This table 608 contains the username and password used by the retailer at that site 30, and is also connected to an entry into a defaults table 610. The defaults table contains some defaults that are to be set for each auction at the auction site 30, such as the type of counter, a logo or icon to be used on the site 30, and the pre-close and post-close period to be used. When an entry in the auctions table 606 is created, the defaults found in the default table 610 are used to complete the same fields in the auction table. Of course, these defaults can be overridden by the sales manager 70 when the item is assigned or by the sales agent 50 during the posting process. Hence, these fields are also found in the auction table 606.

The auction table 606 contains the following information for an individual auction:

the start date, duration and end date;

the pre-close period and post-close period;

the start price, the reserve price, and buy-it-now price;

the region, the presentation options used for the auction, the counter selection, and the logo/icon choice;

the number of bids received during the auction, the highest bidder, and the highest bid amount;

the auction title, number of bids, and highest bid; and

the sales agent assigned to the auction.

Each sales person 50 and sales manager 70 are recorded in the agent table 612 and identified by an agent ID number. A sales manager 70 is distinguished from a sales person 50 by a user level field. In addition, the agent table 612 tracks the individuals name; contact information such as e-mail account, phone number, and address; a password for the computing system 80; a token and token timestamp which is used in the security of the computing system 80 to grant a user limited time access to the system 80; and a “deleted” field that allows an easy way to keep a person from accessing the system without actually deleting an entry in the agent table 612.

Bids from bidders 40 are recorded in a bid table 614. This table contains information about both a bidder 40 and a bid. Traditionally, these two types of information would be separated into different tables. The present invention combines this information into a single table 614 for performance reasons. A bidder ID uniquely identifies each entry in the bid table 614. A separate entry is created each time a bidder 40 places a bid on a new auction in table 606. If a bidder 40 places a subsequent bid on the same auction, a new record is not created in the bid table 614. Rather, the previously created record is updated to reflect the new bid. Thus, only the bidder's most recent (and highest) bid on an item 20 is recorded in table 614. This table 614 records the bid amount and time, as well as information about the bidder 40 such as name, phone number, e-mail address, and physical address including zip code.

It is often easier to obtain the zip code of a bidder 40 than their complete physical address. Thus, the zip code table 616 is used in the present invention to associate a particular zip code with a city, state, county, longitude, and latitude. The latter two characteristics are used in the present invention to present sales managers 70 and sales agents 50 a map containing indicators where each bidder 40 resides. The presentation of this information in a graphical form allows sales managers 70 to easily determine the areas of the country in which most bids are being placed, thereby assisting the selection of an appropriate region for future auctions of similar items 20. Alternatively, the present invention could use phone numbers, area codes, or even IP addresses in place of zip codes as the geographic locator of a bidder 40.

E-mails and other communications between an agent are recorded as communications in conversation table 618, which links a record in agent table 612 with a record in bid table 614. Each record in this table also records the auction's item number, to make an easy connection between each communication and a particular auction in table 606. Individual messages that form part of a conversation are recorded in table 620, and are assigned a priority, from and to addresses, a subject, and a text field to contain the message.

Authentication of Ownership

The present invention also includes a unique system to provide bidders 40 with an assurance that the item upon which they are bidding is actually owned by the seller identified on the auction site 30, at least where the item 20 is a vehicle identified with a vehicle identification number (or VIN number). This aspect of the present invention prevents a situation where a fraudulent party gathers information about an actual vehicle, such as the vehicles make, model, miles, year, color, and VIN number. In fact, it is relatively easy to obtain actual photographs of the vehicle from a dealer web site, including photographs of the plate containing the VIN number. This fraudulent party then creates an auction for that vehicle on an auction site 30. When the auction is over, the winning bidder 40 is asked to forward money to the fraudulent party as a down payment on the vehicle. With the advent of electronic cash and the anonymity of e-mail, it can be difficult to ever recover the money or to track down the fraudulent party once the fraud is discovered.

The present invention verifies that the current registered owner of the vehicle has the same address and/or name as the seller listed on the auction site 30. The auction site 30 could accomplish this when the auction is first posted. Auction sites 30 traditionally will ask for the VIN number of all vehicles being sold as well as basic information about the car's make, model, and year. This information then be compared with known automobile databases containing ownership information, such as those provided by Carfax.com (Fairfax, Va.) or Autocheck.com (provided by Experian, Orange, Calif.). If there is a discrepancy between the automobile information entered and the information returned from the database, the auction site 30 could reject the auction. Furthermore, if there is a discrepancy between the ownership information returned by these databases and the information that the auction site 30 maintains in its database about the seller (a different name or a different address), further fraud investigation could take place. Alternatively, a statement could be attached to those auctions passing this verification test, such as a statement saying “the above vehicle was verified owned by Dealer Name at Address on date of xx/xx/xx.”

The invention is not to be taken as limited to all of the details thereof as modifications and variations thereof may be made without departing from the spirit or scope of the invention. For instance, while the present invention is discussed using the example of automobiles as the items 20 being placed for auctions, the invention is equally applicable to other types of items 20. Furthermore, the above description describes the communications between bidders and sales agents as occurring via e-mail. One skilled in the art would be aware that other communication techniques could be used, such as by allowing bidders to directly enter messages into the database of the present invention through a browser interface. The above description also describes the database 10 as a plurality of related tables shown in FIG. 16. It would be a simple matter to changes the number and content of the tables of data model 600 and still implement the present invention. It would also be a simple matter to implement the functional characteristics of the database without using relational tables, such as by using an object-oriented database. Consequently, the invention should be limited only by the following claims.

What is claimed is:

1. A method for submitting items to an automated auction site via a computerized system comprising:
a) creating a computerized inventory database containing data on multiple items;
b) assigning a first item in the inventory database to a first sales person;
c) assigning a second item in the inventory database to a second sales person;
d) using the information in the computerized inventory database to post the first and second items to the automated auction site, the posting being done under a single seller identity having a single communications path;
e) receiving a first message concerning the first item on the single communications path;
f) receiving a second message concerning the second item on the single communication path;
g) routing the first message to the first sales person and the second message to the second sales person.

2. The method of claim 1, wherein the first sales person is not granted access to view the second message and the second sales person is not granted access to view the first message.

3. The method of claim 2, further comprising the steps of:
h) tracking the receipt of the first message, and
i) preventing the posting of a third item assigned to the first sales person until the first sales person responds to the first message.

4. The method of claim 1, further comprising the steps of:
h) assigning a third item to the first sales person, and
i) preventing the posting of the third item to the automated auction site until the first item is posted to the automated auction site.

5. The method of claim 1, wherein the steps of assigning the first and second items are accomplished by defining a first group of items containing the first item and a second group of items containing the second item, and assigning the first group of items to the first sales person and the second group of items to the second sales person.

6. The method of claim 1, wherein the step of routing the first and second message is accomplished by examining the content of the first and second message for identifying information found in the computerized inventory database.

7. A method for submitting items to an automated auction site via a computerized system comprising:
a) creating a computerized inventory database on the computerized system containing data on multiple items;
b) posting a first item and a second item to the automated auction site under a single seller identity having a single communications path;
c) receiving a first message concerning the first item on the single communications path;
d) receiving a second message concerning the second item on the single communication path;
e) routing the first message to a first mail box and the second message to the second sales person, wherein the routing is accomplished by examining the content of the first and second message for identifying information found in the computerized inventory database.

8. The method of claim 7, wherein the first and second mail boxes are Internet mail boxes using a protocol chosen from the set of IMAP and POP.

9. The method of claim 7, wherein the first and second mail boxes are constructs in a message database.

10. The method of claim 9, wherein the message database is integrated with the computerized inventory database.

11. The method of claim 7, wherein a first person is granted access to the first mail box but not granted access to the second mail box, while a second person is granted access to the second mail box but not granted access to the first mail box.

12. The method of claim 11, wherein the first item is assigned to the first person and the second item is assigned to the second person prior to the posting of the first and second items.

13. A method for submitting items to an automated auction site via a computerized system comprising:
a) acquiring data on multiple items in an inventory database operating on the computerized system;
b) posting a first item from the inventory database to a first automated auction site; and
c) posting a second item from the inventory database to a second automated auction site not affiliated with the first automated auction site.

14. The method of claim 13, wherein the first item is submitted to the first automated auction site under a first site seller identity having a communications path, and wherein the second item is submitted to the automated auction site under a second site seller identity having the same communications path as the first site seller identity.

15. The method of claim 14, further comprising the steps of:
d) receiving a first message from a first bidder concerning the first item on the single communications path;
e) receiving a second message from a second bidder concerning the second item on the single communication path; and
f) routing the first message to a first sales person and the second message to a second sales person, wherein the routing is based upon the content of the message.

16. A method for submitting items for an auction on an automated auction site via a computerized system comprising:
a) creating a computerized inventory database on the computerized system containing data on multiple items;
b) assigning an item to a sales person on the direction of a sales manager;
c) allowing the sales manager to store a confidential value to the item in the computerized inventory database, the confidential value being required for submission to the automated auction site;
d) allowing the sales person to post the item to the automated auction site using the confidential information without allowing the sales person to access the confidential information;
e) routing communication received from bidders concerning the item to the sales person; and
f) preventing the sales person from accessing the confidential value during the auction.

17. The method of claim 16, wherein the confidential value is a reserve price for the item.

18. The method of claim 16, wherein the sales person verifies and supplements non-confidential information about the item the is used to post the item to the automated auction site.

19. A method using a computerized system for managing a sales person responsible for managing on line auctions, the method comprising:
a) providing the sales person with a computerized system for performing actions, the actions being one or more items chosen from the set of:
i) posting items to the on-line auction;
ii) responding to communications received from bidders concerning the items;
iii) tracking follow up to do items relating to the on line auction;
b) tracking the performance of actions by the sales person through the computerized system; and
c) preventing the sales person from performing certain actions through the computerized system until other actions are completed.

20. The method of claim 19, wherein the sales person is prevented from performing any other items until a mandatory to do item is completed.

21. The method of claim 19, wherein the sales person is prevented from performing any other items until the sales person responds to a priority bidder communication.

22. The method of claim 21, wherein all communications from the bidder are priority bidder communications.

23. The method of claim 19, wherein items are assigned to the sales person in a particular order, and further wherein the sales person is prevented from posting the items other than in the particular order.

24. A method for assigning items to a sales person for posting to an automated auction site, the method comprising:
a) creating a computerized inventory database on the computerized system containing data on multiple items;
b) assigning an item to a sales person;
c) allowing the sales person to verify and supplement data on the item in the computerized inventory database;
d) allowing the sales person to post the item to the automated auction site using the data in the computerized inventory database; and
e) revoking the assignment of the item to the sales person if the item is not posted to the automated auction site within a predetermined amount of time.

25. A method for verifying the ownership of a vehicle being posted for sale by a seller on an automated auction site comprising:
a) requiring the seller to register with the automated auction site by entering a seller name and a seller address;
b) requiring the vehicle identification number and vehicle description to be entered by the seller during the posting process;
c) submitting the vehicle identification number to a vehicle information database that returns one or more database values about the vehicle;
d) comparing at least one of the database values with information entered by the seller.

26. The method of claim 25, wherein database value is the name of the registered owner of the vehicle, which is compared with the seller name.

27. The method of claim 26, wherein a second database value is the address of the registered owner of the vehicle, which is compared with the seller address.

28. The method of claim 25, wherein the database value is the address of the registered owner of the vehicle, which is compared with the seller address.

29. The method of claim 25, wherein the database value is a description of the vehicle, which is compared with vehicle description entered by the seller.

30. The method of claim 25, wherein multiple database values are compared with information entered by the seller.

31. The method of claim 25, wherein the vehicle identification number is submitted to multiple vehicle information databases to return multiple database values about the vehicle.

32. A system for submitting items to an automated auction site comprising:
a) a database containing representations of the following data—
i) items,
ii) sales persons, and
iii) auctions, wherein each auction representation includes an indication of one item associated with the auction and one sales person assigned to the item for the auction;
b) a inventory interface that accepts information about the items for the database;
c) a manager interface that allows an auction representation in the database to be created by identifying the one sales person assigned to the item for the auction and that allows private information about the item to be entered;
d) a sales person interface that allows the sales person to review some information about the item assigned to the sales person without allowing the sales person to review the private information; and
e) a submission interface for submitting to the automated auction site information about the item identified in the auction representation of the database including the private information.

33. The system of claim 31, wherein the database is chosen from the set of a relational database and an object-oriented database.

34. The system of claim 31, wherein the indication of one sales person assigned to the item for the auction further includes an indication of additional sales persons assigned to the item for the auction.

35. A system for routing communications responding to an auction on an automated auction site to sales persons assigned to an auction comprising:
a) a database containing information about a plurality of items, auctions, and sales agents, the database indicating a particular sales person assigned to a particular item included in a particular auction;
b) a communication reception unit for receiving along a single communications path a plurality of communications related to the plurality of auctions assigned to a plurality of sales persons;
c) a plurality of mail boxes, each mail box accessible by at least one sales person while also being inaccessible by at least one sales person;
d) a router for examining the content of the communications, the router comparing the content with information contained in the database to determine an appropriate mail box for the communication;
e) wherein a communication relating to the particular auction is received along the single communication path and routed to the appropriate mail box that is accessible to the particular sales person as indicated by the database.

36. The system of claim 34, where the communication is an e-mail message and the single communications path is a single e-mail address.
